(19) United States
(12) Patent Application Publication
(10) Pub. No.: US 2024/0340998 A1
(43) Pub. Date: Oct. 10, 2024

(54) DYNAMIC INDICATION TO SKIP CHANNEL RECEPTION OR TRANSMISSION

(71) Applicant: QUALCOMM Incorporated, San Diego, CA (US)

(72) Inventors: Hung Dinh LY, San Diego, CA (US); Peter GAAL, San Diego, CA (US)

(21) Appl. No.: 18/431,157

(22) Filed: Feb. 2, 2024

Related U.S. Application Data
(60) Provisional application No. 63/494,444, filed on Apr. 5, 2023.

(51) Int. Cl. H04W 76/28

(52) U.S. Cl. CPC H04W 76/28

(57) ABSTRACT

Various aspects of the present disclosure generally relate to wireless communication. In some aspects, a user equipment (UE) may receive a configuration of cell discontinuous transmission (DTX) and cell discontinuous reception (DRX). The UE may receive a dynamic indication to skip reception or transmission of one or more channels during a time interval. Numerous other aspects are described.

### CROSS-REFERENCE TO RELATED APPLICATION

This Patent application claims priority to U.S. Provisional Patent Application No. 63/494,444, filed on Apr. 5, 2023, entitled “CONFIRMATION OF DYNAMIC INDICATION TO SKIP RECEPTION OR TRANSMISSION DURING TIME INTERVAL,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for a dynamic indication to skip channel reception or transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive a configuration of cell discontinuous transmission (DTX) and cell discontinuous reception (DRX). The one or more processors may be configured to receive a dynamic indication to skip reception or transmission of one or more channels during a time interval.

Some aspects described herein relate to a network node for wireless communication. The network node may include a memory and one or more processors coupled to the memory. The one or more processors may be configured to transmit a configuration of cell DTX and cell DRX. The one or more processors may be configured to transmit a dynamic indication to skip reception or transmission of one or more channels during a time interval.

Some aspects described herein relate to a method of wireless communication performed by a UE. The method may include receiving a configuration of cell DTX and cell DRX. The method may include receiving a dynamic indication to skip reception or transmission of one or more channels during a time interval.

Some aspects described herein relate to a method of wireless communication performed by a network node. The method may include transmitting a configuration of cell DTX and cell DRX. The method may include transmitting a dynamic indication to skip reception or transmission of one or more channels during a time interval.

Some aspects described herein relate to a non-transitory computer-readable medium that stores a set of instructions for wireless communication by a UE. The set of instructions, when executed by one or more processors of the UE, may cause the UE to receive a configuration of cell DTX and cell DRX. The set of instructions, when executed by one or more processors of the UE, may cause the UE to receive a dynamic indication to skip reception or transmission of one or more channels during a time interval.

Some aspects described herein relate to a non-transitory computer-readable medium that stores a set of instructions for wireless communication by a network node. The set of instructions, when executed by one or more processors of the network node, may cause the network node to transmit a configuration of cell DTX and cell DRX. The set of instructions, when executed by one or more processors of the network node, may cause the network node to transmit a dynamic indication to skip reception or transmission of one or more channels during a time interval.

Some aspects described herein relate to an apparatus for wireless communication. The apparatus may include means for receiving a configuration of cell DTX and cell DRX. The apparatus may include means for receiving a dynamic indication to skip reception or transmission of one or more channels during a time interval.

Some aspects described herein relate to an apparatus for wireless communication. The apparatus may include means for transmitting a configuration of cell DTX and cell DRX. The apparatus may include means for transmitting a dynamic indication to skip reception or transmission of one or more channels during a time interval.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station (BS) architecture, in accordance with the present disclosure.

FIG. 4 is a diagram illustrating an example of a discontinuous reception (DRX) configuration, in accordance with the present disclosure.

FIG. 5A is a diagram illustrating an example of restriction windows configured during UE connected mode DRX (C-DRX) cycle operation, in accordance with the present disclosure.

FIG. 5B is a diagram illustrating an example of restriction windows that are configured when a UE is not configured with UE C-DRX, in accordance with the present disclosure.

FIG. 6 is a diagram illustrating an example in which a dynamic indication is configured to skip the reception of semi-persistent scheduling (SPS) transmissions at a UE during the inactive times of a DRX configuration, in accordance with the present disclosure.

FIG. 7 is a diagram illustrating an example in which a dynamic indication is configured to skip the transmission of configured grants (CGs) by a UE during the inactive times of a DRX configuration, in accordance with the present disclosure.

FIG. 8 is a diagram illustrating an example associated with a dynamic indication to skip channel reception or transmission, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Cell discontinuous transmission (DTX)/discontinuous reception (DRX) may involve cell non-active times during which a base station (BS) may enter a sleep state. Thus, cell DTX/DRX may enable the BS to reduce power consumption. Cell DTX/DRX may be configured with or without a corresponding user equipment (UE) discontinuous reception (DRX) cycle (e.g., a connected mode DRX (C-DRX) cycle). For example, cell DTX/DRX may be configured when the BS is connected with one or more UEs that are configured with C-DRX, or when the BS is connected with one or more UEs that are not configured with C-DRX. A UE C-DRX cycle may include an active time (e.g., during which a UE is awake or in an active state) and an inactive time (e.g., during which the UE may enter a sleep state). The UE may monitor a physical downlink control channel (PDCCH) during the active time, and may refrain from monitoring the PDCCH during the inactive time. The DRX cycle may repeat with a configured periodicity according to a DRX configuration. By entering the sleep state periodically, the UE may conserve battery power and reduce power consumption. In cases where cell DTX/DRX is configured with a corresponding UE C-DRX cycle, one or more non-active times of the cell DTX/DRX may be aligned with one or more inactive times of the UE C-DRX cycle.

A BS may provide a dynamic indication to skip reception or transmission of one or more channels during a time interval (e.g., during an inactive time). The indication may be “dynamic” because the BS may configure the UE to skip the reception or transmission of the channel(s) (e.g., via the dynamic indication) at any suitable time. By notifying the UE of the time in which the skipping is to be enabled, the dynamic indication may prevent one or more transmissions from occurring during the inactive time. As a result, the BS and/or the UE may remain in or enter a sleep state during the inactive time. For example, applying the dynamic indication in a UE C-DRX configuration and operation scenario may enable cell DTX/DRX, which may enable the BS to reduce power consumption. For example, the cell DTX/DRX mechanism may be achieved via C-DRX operation with proper C-DRX configurations across connected mode UEs in or connected to the cell (e.g., a BS).

However, in some cases, the UE may not receive the dynamic indication. For example, the UE may not receive the dynamic indication from the BS when the UE is at an edge of a cell associated with the BS and/or when the UE is under high interference (e.g., when the UE is experiencing interference above a threshold). If the UE does not receive the dynamic indication and the BS enters a sleep state during the inactive time, then the UE may remain awake during the inactive time. For example, during the inactive time, the UE may expend resources to monitor for transmissions that the BS will not send (e.g., because the BS is in a sleep state).

Some implementations presented herein provide for a confirmation that the dynamic indication was received. In some examples, the BS may output, and the UE may receive, a configuration of cell DTX and cell DRX. The BS may further output, and the UE may further receive, a dynamic indication to skip reception or transmission of one or more channels during a time interval. The time interval may correspond to a non-active time of the cell DTX or a non-active time of the cell DRX. In some examples, the UE may transmit, and the BS may obtain, a confirmation that the dynamic indication was received.

The confirmation may enable the UE to indicate, to the BS, that the dynamic indication was received. For example, based on the confirmation, the BS and UE may enter respective sleep states in a coordinated fashion (e.g., during the time interval). If the BS does not receive the confirmation (e.g., within a threshold amount of time), then the BS may refrain from entering a sleep state and/or the BS may output a subsequent dynamic indication to skip reception or transmission of one or more channels during a time interval. Thus, the confirmation may help ensure that the UE has been notified to skip the reception and/or transmission of the channel(s) and, therefore, that the UE does not expend resources to monitor for transmissions that the BS will not send.

In some aspects, the dynamic indication may be included in downlink control information (DCI). For example, the DCI may not include an uplink grant or a downlink grant and, thus, may have no associated physical uplink shared channel (PUSCH) or physical downlink shared channel (PDSCH). The BS may output the DCI flexibly (e.g., at any suitable time) without waiting for an occurrence that would enable the transmission of the DCI.

In some aspects, the dynamic indication may be included in a DCI that also includes a downlink grant for a broadcast PDSCH. In some examples, the network node 110 may transmit the DCI and/or the broadcast PDSCH to multiple UEs simultaneously (e.g., in a cell-specific or UE-group manner), which may help reduce resources involved in transmitting the DCI and/or the broadcast PDSCH, compared to providing respective transmissions to each UE associated with the cell.

In some aspects, the dynamic indication may be included in a DCI that also includes a downlink grant for a unicast PDSCH or an uplink grant for a unicast PUSCH. In some examples, the DCI (e.g., the downlink grant), and the unicast PDSCH or the unicast PUSCH, may be transmitted regardless of whether the dynamic indication is present in the DCI. Thus, the UE 120 may transmit the confirmation as a transmission that would be transmitted regardless of whether the dynamic indication is present in the DCI, which may result in lower overhead involved in transmitting the confirmation (e.g., the overhead may be below a threshold) than if the UE 120 was to transmit a separate, dedicated confirmation.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

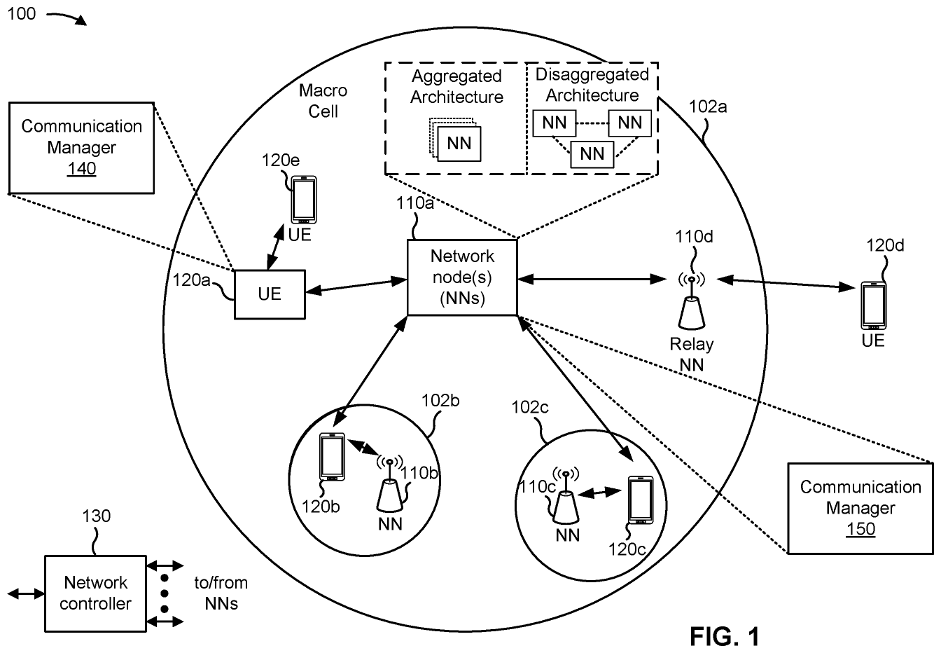

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated BS), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR BS, an LTE BS, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “BS” or “network node” may refer to an aggregated BS, a disaggregated BS, an integrated access and backhaul (IAB) node, a relay node, or one or more components thereof. For example, in some aspects, “BS” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “BS” or “network node” may refer to one device configured to perform one or more functions, such as those described herein in connection with the network node 110. In some aspects, the terms “BS” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “BS” or “network node” may refer to any one or more of those different devices. In some aspects, the terms “BS” or “network node” may refer to one or more virtual BSs or one or more virtual BS functions. For example, in some aspects, two or more BS functions may be instantiated on a single device. In some aspects, the terms “BS” or “network node” may refer to one of the BS functions and not another. In this way, a single device may include more than one BS.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay BS, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration of cell DTX and cell DRX; and receive a dynamic indication to skip reception or transmission of one or more channels during a time interval. Additionally, or alternatively, the communication manager 140 may perform one or more other operations described herein.

In some aspects, the network node 110 may include a communication manager 150. As described in more detail elsewhere herein, the communication manager 150 may transmit a configuration of cell DTX and cell DRX; and transmit a dynamic indication to skip reception or transmission of one or more channels during a time interval. Additionally, or alternatively, the communication manager 150 may perform one or more other operations described herein.

As indicated above, FIG. 1 is provided as an example. Other examples may differ from what is described with regard to FIG. 1.

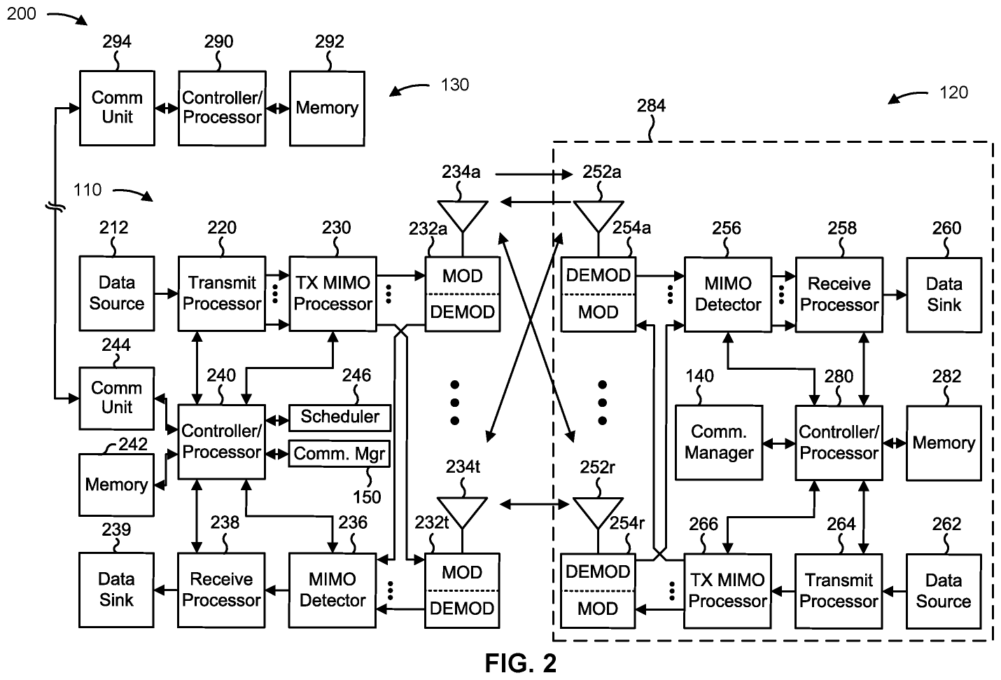

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (SI) (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and SI to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

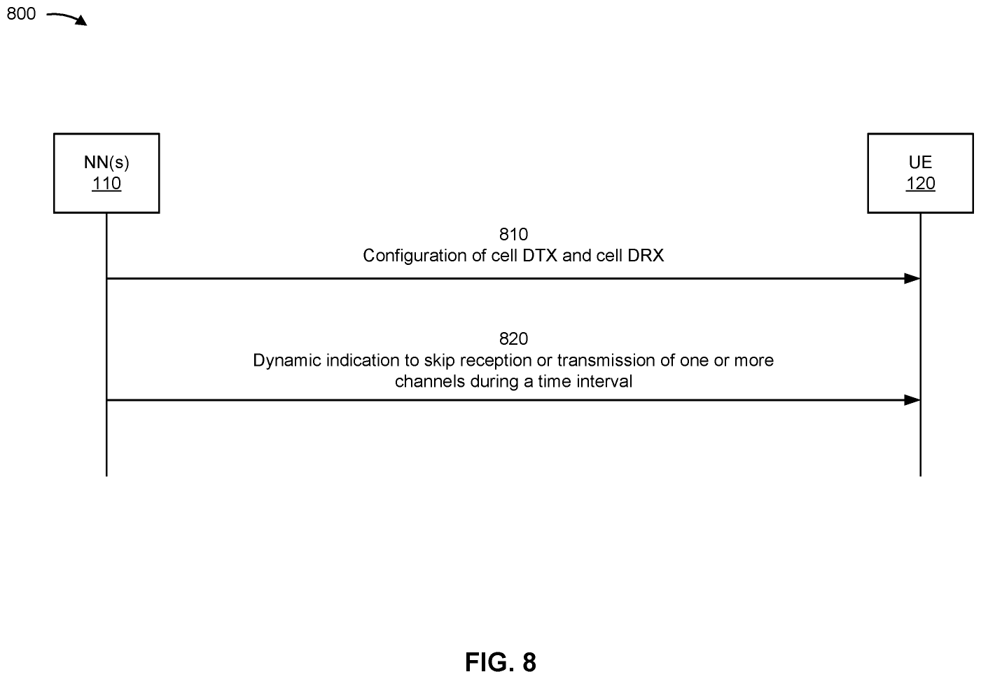

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-12).

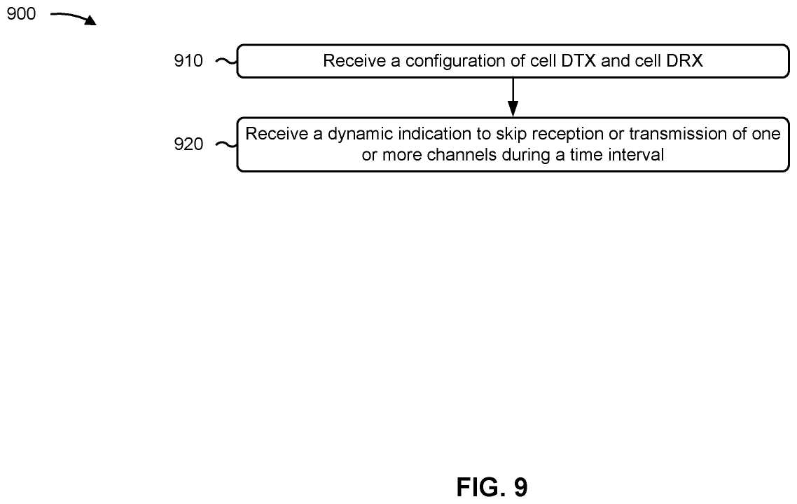

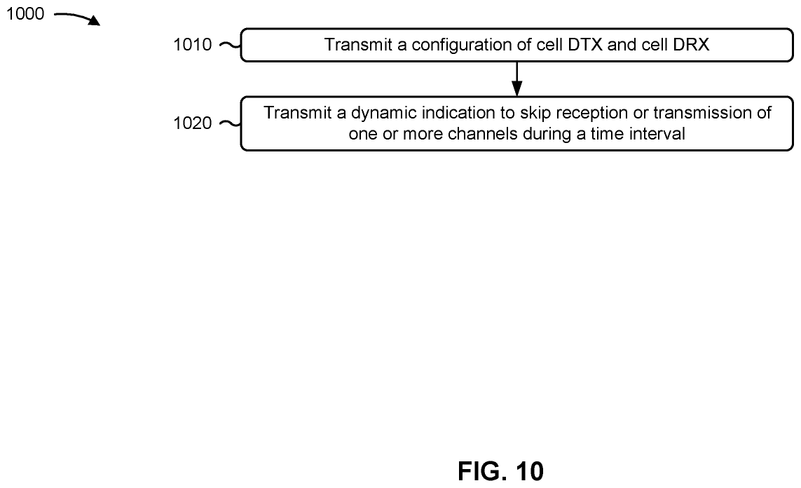

The controller/processor 240 of the network node 110, the controller/processor 280 of the UE 120, and/or any other component(s) of FIG. 2 may perform one or more techniques associated with a dynamic indication to skip channel reception or transmission, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving a configuration of cell DTX and cell DRX; and/or means for receiving a dynamic indication to skip reception or transmission of one or more channels during a time interval. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for means for transmitting a configuration of cell DTX and cell DRX; and/or transmitting a dynamic indication to skip reception or transmission of one or more channels during a time interval. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

Reference to “one or more memories” should be understood to refer to any one or more memories of a corresponding device, such as the memory described in connection with FIG. 2. For example, an operation described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a BS, or a network equipment may be implemented in an aggregated or disaggregated architecture. For example, a BS (such as a Node B (NB), an evolved NB (CNB), an NR BS, a 5G NB, an access point (AP), a TRP, or a cell, among other examples), or one or more units (or one or more components) performing BS functionality, may be implemented as an aggregated BS (also known as a standalone BS or a monolithic BS) or a disaggregated BS. “Network entity” or “network node” may refer to a disaggregated BS, or to one or more units of a disaggregated BS (such as one or more CUs, one or more DUs, one or more RUs, or a combination thereof).

An aggregated BS (e.g., an aggregated network node) may be configured to utilize a radio protocol stack that is physically or logically integrated within a single RAN node (e.g., within a single device or unit). A disaggregated BS (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

BS-type operation or network design may consider aggregation characteristics of BS functionality. For example, disaggregated BSs may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating BS functionality into one or more units that can be individually deployed. A disaggregated BS may include functionality implemented across two or more units at various physical locations, as well as functionality implemented for at least one unit virtually, which can enable flexibility in network design. The various units of the disaggregated BS can be configured for wired or wireless communication with at least one other unit of the disaggregated BS.

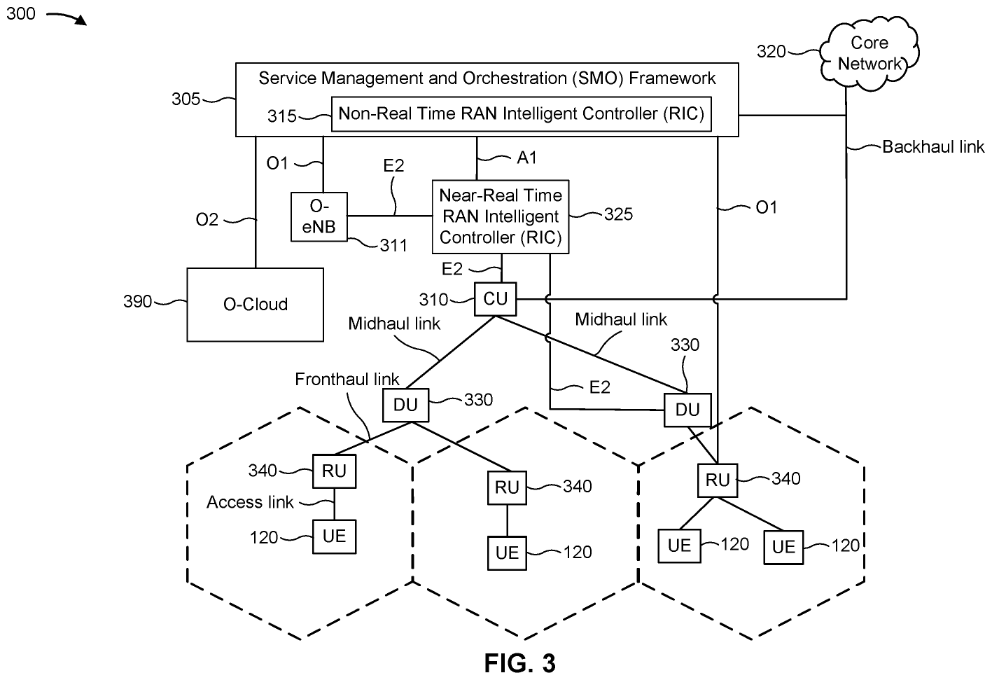

FIG. 3 is a diagram illustrating an example disaggregated BS architecture 300, in accordance with the present disclosure. The disaggregated BS architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more BS functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as AI interface policies).

As indicated above, FIG. 3 is provided as an example. Other examples may differ from what is described with regard to FIG. 3.

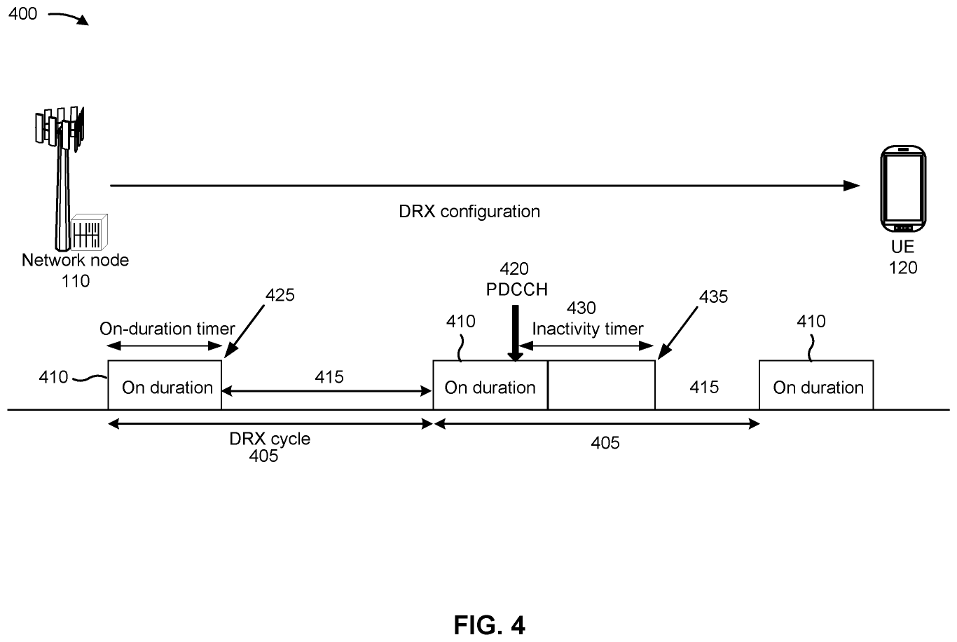

FIG. 4 is a diagram illustrating an example 400 of a DRX configuration, in accordance with the present disclosure. As shown in FIG. 4, a network node 110 may transmit a DRX configuration to a UE 120 to configure a DRX cycle 405 for the UE 120. The DRX cycle may include an active time (e.g., DRX on duration 410, during which a UE 120 is awake or in an active state) and an inactive time (e.g., during which the UE 120 may enter a DRX sleep state 415). As described below, the UE 120 may monitor a PDCCH during the active time, and may refrain from monitoring the PDCCH during the inactive time.

In some examples, when DRX is configured, an “active time” for serving cells in a DRX group may include the time while: drx-onDurationTimer or drx-InactivityTimer configured for a DRX group is running; drx-RetransmissionTimerDL, drx-RetransmissionTimerUL, or drx-RetransmissionTimerSL is running on any serving cell in the DRX group; or ra-ContentionResolutionTimer or msgB-Response Window is running. In some examples, when DRX is configured, the “active time” for the serving cells may include the time while a scheduling request is sent on the physical uplink control channel (PUCCH) and is pending. If the serving cell is part of a non-terrestrial network, the active time may be started after the scheduling request (SR) transmission that is performed when the SR_COUNTER is 0 for all of the SR configurations with pending SR(s) plus the UE-gNB round trip time. In some examples, when DRX is configured, the “active time” for the serving cells may include the time while a PDCCH indicating a new transmission addressed to the cell radio temporary identifier (C-RNTI) of a MAC entity has not been received after successful reception of a random access response for a random access preamble not selected by the MAC entity among the contention-based random access preamble. In some examples, the “inactive time” may be any time in a DRX cycle that does not occur during the active time.

During the DRX on duration 410 (e.g., the active time), the UE 120 may monitor a downlink control channel (e.g., a PDCCH), as shown by reference number 420. For example, the UE 120 may monitor the PDCCH for DCI pertaining to the UE 120. If the UE 120 does not detect and/or successfully decode any PDCCH communications intended for the UE 120 during the DRX on duration 410, then the UE 120 may enter the sleep state 415 (e.g., for the inactive time) at the end of the DRX on duration 410, as shown by reference number 425. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 430 (e.g., which may extend the active time). The UE 120 may start the DRX inactivity timer 430 at a time at which the PDCCH communication is received (e.g., in a transmission time interval (TTI) in which the PDCCH communication is received, such as a slot or a subframe). The UE 120 may remain in the active state until the DRX inactivity timer 430 expires, at which time the UE 120 may enter the sleep state 415 (e.g., for the inactive time), as shown by reference number 435. During the duration of the DRX inactivity timer 430, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a PUSCH) scheduled by the PDCCH communication. The UE 120 may restart the DRX inactivity timer 430 after each detection of a PDCCH communication for the UE 120 for an initial transmission (e.g., but not for a retransmission). By operating in this manner, the UE 120 may conserve battery power and reduce power consumption by entering the sleep state 415.

As indicated above, FIG. 4 is provided as an example. Other examples may differ from what is described with respect to FIG. 4.

A BS may also be configured to enter a sleep state. For example, the cell DTX/DRX mechanism may be achieved via C-DRX operation with proper C-DRX configurations across connected mode UEs in or connected to the cell (e.g., a BS). Because the BS may be responsible for scheduling downlink and uplink transmissions, the BS may enter a sleep state dynamically (e.g., without an explicit definition or configuration for cell DTX/DRX operations). For example, the BS may enter a sleep state during a time interval in which there are no scheduled uplink transmissions and/or no scheduled downlink transmissions. Entering the sleep state may enable the BS to reduce power consumption.

Certain uplink or downlink transmissions may be scheduled outside a C-DRX active time. Examples of transmissions received by the UE outside a C-DRX active time may include an SI transmission, a paging transmission, a radio resource management (RRM) reference signal (RS), a radio link monitoring (RLM) RS, a beam management (BM) RS, a beam failure detection (BFD) RS, a semi-persistent scheduling (SPS) PDSCH/PDCCH transmission, a dynamic grant (DG) PDSCH transmission scheduled by a PDCCH transmission during the C-DRX active time (e.g., when KO is larger than the inactivity timer), or the like. Examples of transmissions transmitted by the UE outside a C-DRX active time may include a scheduling request (SR), a configured grant, a random access channel (RACH) (e.g., a PRACH-ResourceDedicatedBFR parameter for beam failure recovery), a DG PUSCH transmission scheduled by a PDCCH transmission during the C-DRX active time, a PUCCH transmission carrying a hybrid automatic repeat request acknowledgement (HARQ-ACK) for a PDSCH transmissions scheduled by a PDCCH transmission during the C-DRX active time, or the like.

Because certain uplink or downlink transmissions may be scheduled during the inactive time, the UE may perform transmission and/or reception for one or more pre-configured signals or channels outside the C-DRX active time. Therefore, in cases where a transmission occurs during an inactive time, opportunities for the BS to enter deep sleep modes for network power savings may be reduced relative to cases where a transmission does not occur during the inactive time. For example, the transmission may prevent the BS from entering into a sleep that is deeper than a micro-sleep that persists at symbol-level graduality.

In some examples, a BS may output a dynamic indication to skip a reception or transmission of one or more channels. The BS may output the dynamic indication in DCI, a MAC control element (MAC-CE), an RRC message (e.g., semi-statically), or the like. In some examples, the dynamic indication may indicate whether or not the skipping is enabled for configured transmissions, uplink and/or downlink channels, signals, or the like. In some examples, the dynamic indication may specify which transmissions, uplink and/or downlink channels, signals, or the like are to be skipped.

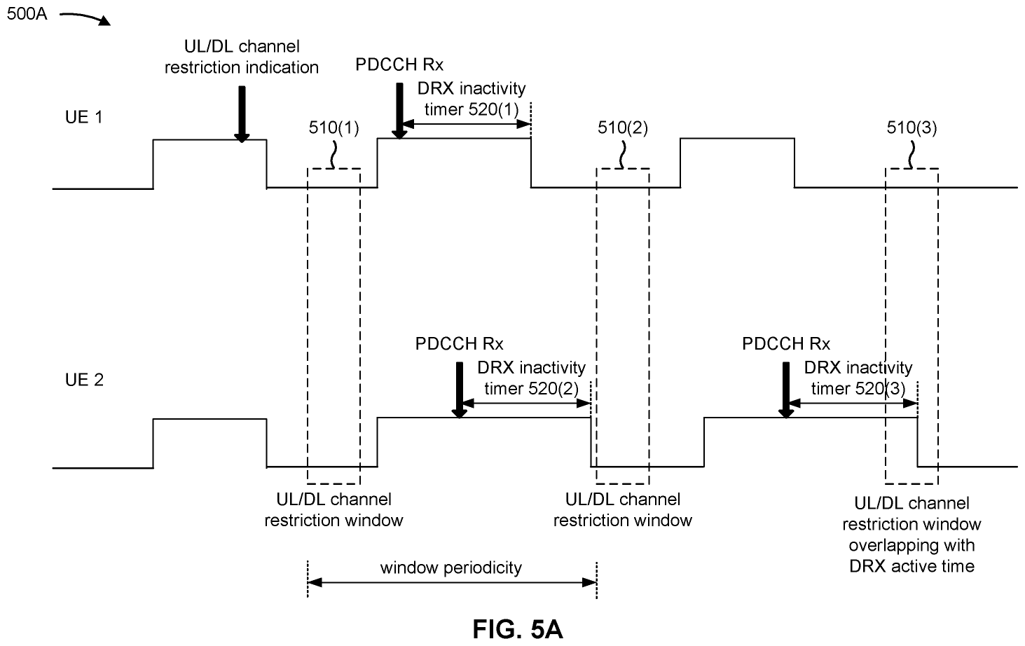

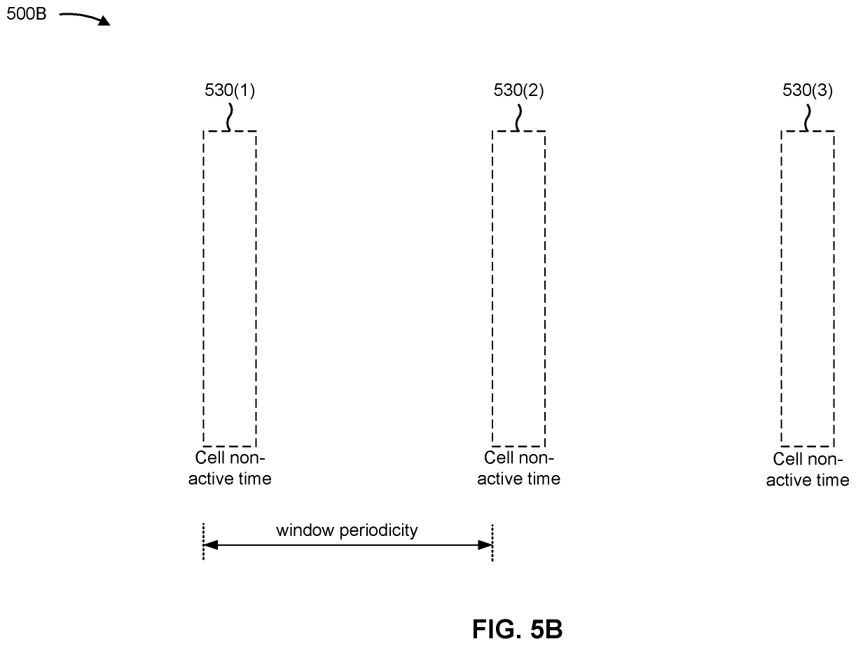

FIG. 5A is a diagram illustrating an example 500A of restriction windows (e.g., durations) 510(1)-510(3) configured during UE C-DRX operation, in accordance with the present disclosure. FIG. 5A depicts C-DRX cycles for two UEs (UE 1 and UE 2) and restriction windows 510(1)-510(3) that occur periodically during C-DRX cycles. The UEs may be connected to the same BS.

Both C-DRX cycles include active times and inactive times. As shown, during one of the active times, UE 1 obtains a dynamic indication (“UL/DL channel restriction indication”). The dynamic indication may indicate whether the UE transmission/reception skipping is to be applied (e.g., applied in one or more of restriction windows 510(1)-510(3)). As further shown, during another active time, UE 1 may obtain a PDCCH (“PDCCH Rx”), which may trigger a DRX inactivity timer 520(1). The ending time of the DRX inactivity timer 520(1) may coincide with the ending time of the active time in which the PDCCH was received. UE 2 may also obtain PDCCHs (“PDCCH Rx”) during respective active times. The PDCCHs may trigger DRX inactivity timers 520(2) and 520(3). The ending times of the respective DRX inactivity timers 520(1)-520(3) may coincide with the ending times of the respective active times in which the respective PDCCHs were received.

During the restriction windows 510(1)-510(3), the BS may apply the cell DTX/DRX mechanism (e.g., the BS may enter a sleep state). In some examples, the dynamic indication may be applied when the BS has an opportunity to take advantage of cell DTX/DRX mechanisms (e.g., when the BS has low (e.g., below a threshold) or no load), which may benefit the overall network based on network capacity, network power consumption, or the like.

Cell DTX/DRX may be achieved by imposing restrictions on (e.g., skipping) transmitting and/or receiving one or more pre-configured UL/DL channels/signals (e.g., via the dynamic indication). These restrictions may be applied within the time windows (e.g., the restriction windows 510(1)-510(3)) without impacting UEs operating in idle or inactive mode or performance of UEs operating in a connected mode. For example, the BS may use the cell DTX/DRX mechanism for UE-specific channels (e.g., PDCCH, PUCCH, PDSCH, PUSCH, sounding reference signals (SRSs), aperiodic channel state information reference signals (CSI-RSs) that are transmitted or received by the UE during the C-DRX active time, or the like). Thus, restricting UE transmission and/or reception of channels within the restriction windows 510(1)-510(3) may enable and/or enhance a cell DTX/DRX operation. For example, the restriction windows 510(1)-510(3) may correspond to non-active times of cell DTX/DRX.

In example 500A, the restriction windows 510(1)-510(3) have a given periodicity (“window periodicity”). As illustrated in FIG. 5A, restriction window 510(1) and restriction window 510(2) are fully outside the DRX active times, and restriction window 510(3) may overlap with an active time. The BS may enter a sleep mode during restriction window 510(1) and restriction window 510(2). The BS may remain awake (and/or refrain from entering a deep sleep) for at least the overlap between the active time and the restriction window 510(3). In some examples, restriction windows 510(1)-510(3) may be configured by the BS.

As indicated above, FIG. 5A is provided as an example. Other examples may differ from what is described with respect to FIG. 5A.

FIG. 5B is a diagram illustrating an example 500B of restriction windows 530(1)-530(3) (“cell non-active time,” which may also be referred to as a non-active time or period of cell DTX/DRX) that are configured when a UE is not configured with UE C-DRX, in accordance with the present disclosure. In example 500B, the BS may be configured with a cell DTX/DRX mechanism without a UE C-DRX mechanism (e.g., the cell DTX/DRX mechanism may be configured when the BS is connected with one or more UEs that are not configured with C-DRX).

During the restriction windows 530(1)-530(3), the BS may apply the cell DTX/DRX mechanism (e.g., the BS may enter a sleep state). In some examples, the dynamic indication may be applied when the BS has an opportunity to take advantage of cell DTX/DRX mechanisms (e.g., when the BS has low (e.g., below a threshold) or no load), which may benefit the overall network based on network capacity, network power consumption, or the like.

Cell DTX/DRX may be achieved by imposing restrictions on (e.g., skipping) transmitting and/or receiving one or more pre-configured UL/DL channels/signals (e.g., via the dynamic indication). These restrictions may be applied within the time windows (e.g., the restriction windows 530(1)-530(3)). In example 500B, the restriction windows 530(1)-530(3) have a given periodicity (“window periodicity”). In some examples, restriction windows 530(1)-530(3) may be configured by the BS. The BS may enter a sleep mode during restriction windows 530(1)-530(3). In some examples, channels that are not received or transmitted during a non-active time of cell DTX/DRX may include one or more downlink channels (e.g., channels for SPS, UE-specific search space (USS) PDCCH, PDCCH with DCI format 2_X (where X=0, 1, . . . , 5, or the like), periodic or semi-persistent (P/SP) CSI-RS for one or more channel state information (CSI) reports including rank indicator (RI), or the like) and/or one or more uplink channels (e.g., channels for CG, SR, P/SP SRS (e.g., except SRS for positioning), P/SP CSI report, or the like).

As indicated above, FIG. 5B is provided as an example. Other examples may differ from what is described with respect to FIG. 5B.

Table 1 below summarizes whether UE transmission/reception skipping may be applied within a time window for specific channels, in some examples.

TABLE 1

| | UE drops channel | |
|---|---|---|
| Channel | within window? | UE impact if signal is dropped |
| synchronization | No | The cell DTX/DRX mechanism may |
| signal block | | not impact SSB transmissions. |
| (SSB) | | |
| tracking | No | The UE may not perform time/ |
| reference | | frequency (T/F) tracking based |
| signal | | on a TRS before an on duration |
| (TRS) | | for PDCCH monitoring; hence, the |
| | | cell DTX/DRX mechanism may |
| | | impact PDCCH/PDSCH reception |
| | | performance and UE power |
| | | consumption. SSB-based T/F tracking |
| | | may have a narrow bandwidth, sparse |
| | | transmission, and possible SSB |
| | | collision across cells. |
| | | Idle mode UEs may not use a TRS |
| | | feature for improving T/F tracking |
| | | for paging reception. |
| SI block 1 | No | The cell DTX/DRX mechanism may |
| (SIB1) | | impact idle mode UEs for SIB 1 |
| | | transmissions. |
| SI block 2 and | No | The cell DTX/DRX mechanism may |
| higher (SIB2+) | | impact idle mode UEs for SIB2+ |
| | | transmissions. |
| | | On-demand SI may be used to reduce |
| | | the SI transmissions (e.g., SIB2+ |
| | | transmissions). |
| Paging | No | The cell DTX/DRX mechanism may |
| | | impact earthquake and tsunami |
| | | warning system (ETWS), paging key |
| | | performance indicators (KPIs), |
| | | and idle mode UEs. |
| CSI-RS | Yes | When the UE is configured with a |
| for RRM | | DRX cycle that is greater than 80 |
| | | ms, then the UE may not expect any |
| | | CSI-RS resources to be available |
| | | other than during the active time |
| | | for measurements based on CSI-RS- |
| | | Resource-Mobility. |
| | | The dynamic skipping may be |
| | | applied to a UE that is configured |
| | | with a DRX cycle that is less than |
| | | or equal to 80 ms. |
| CSI-RS | Yes | |
| for RLM | | |
| CSI-RS | No | For some UE implementations, the |
| for BM | | UE may perform BM for beam |
| | | refinement based on CSI-RS before |
| | | the on duration for PDCCH |
| | | monitoring. Therefore, the cell |
| | | DTX/DRX mechanism may impact |
| | | PDCCH reception performance. |
| CSI-RS for | Yes | SSB-based BFD/BFR may |
| BFD/beam | | compensate for any dropped |
| failure | | CSI-RSs for BFD/BFR. |
| recovery (BFR) | | |
| SPS | Yes | |
| RACH for | No | The cell DTX/DRX mechanism may |
| initial access | | impact idle mode UEs. |
| UE-specific | No | The cell DTX/DRX mechanism may |
| RACH | | impact recovery delay for certain |
| | | procedures (e.g., link failure recovery |
| | | (LFR), BFR, uplink synchronization |
| | | recovery, or the like). |
| configured | Yes | |
| grant (CG) | | |
| SR | Yes | |

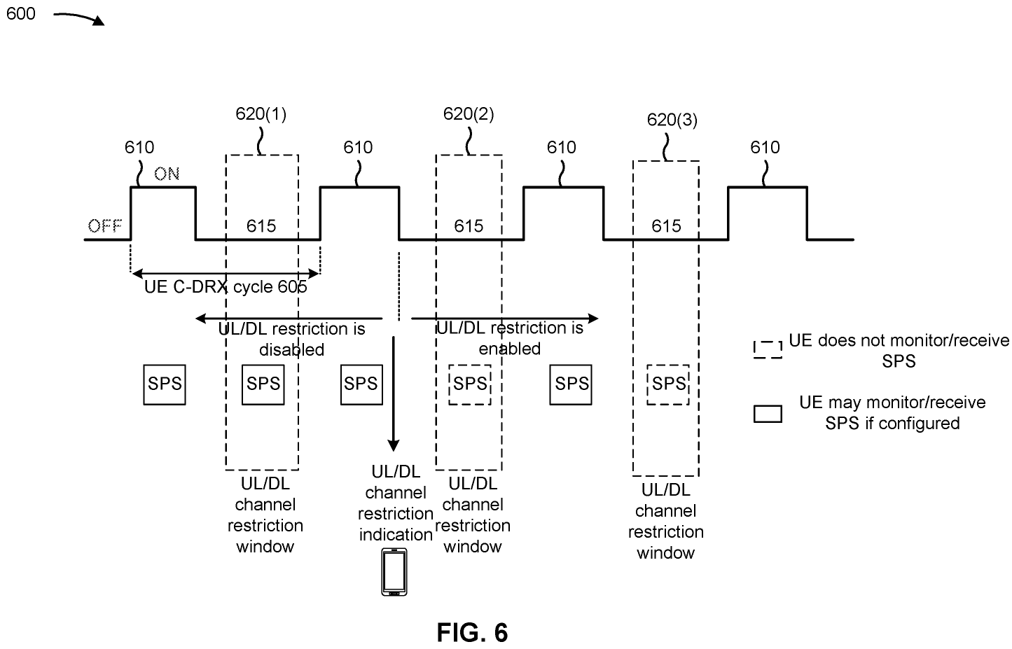

FIG. 6 is a diagram illustrating an example 600 in which a dynamic indication is configured to skip the reception of SPS transmissions at a UE during the inactive times of a DRX configuration, in accordance with the present disclosure. Example 600 depicts a DRX cycle 605 that is implemented on a UE. The DRX cycle 605 may include alternating active times 610 (e.g., on durations) and inactive times 615 (e.g., off durations). In some examples, the DRX cycle 605 may include one on duration and one off duration and may repeat. The UE may be configured to monitor a PDCCH during the active time 610, and to refrain from monitoring the PDCCH during the inactive time 615. In some examples, a BS may be configured to enter a sleep state during the inactive times 615. For example, the BS may be configured to refrain from transmitting communications during the inactive times 615.

In example 600, the BS may be configured to transmit, and the UE may be configured to receive, a periodic SPS PDSCH/PDCCH transmission. For example, one SPS PDSCH/PDCCH transmission may be scheduled during each active time 610 and one SPS PDSCH/PDCCH transmission may be scheduled during each inactive time 615. As shown, before the UE receives the dynamic indication from the BS, the UE receives at least one SPS PDSCH/PDCCH transmission during an inactive time 615. The BS may wake up (or remain awake) during the inactive time 615, which may enable the BS to transmit the SPS PDSCH/PDCCH transmission during the inactive time 615. The UE may wake up (or remain awake) during the inactive time 615, which may enable the UE to monitor for and receive the SPS PDSCH/PDCCH transmission during the inactive time 615. As a result, before the UE receives the dynamic indication, the BS and the UE may consume more power during the inactive time 615 than the BS and the UE would consume without the SPS PDSCH/PDCCH transmission.

As shown, the BS may output, and the UE may receive, a dynamic indication (“UL/DL channel restriction indication”) to skip reception or transmission of one or more channels during an inactive time 615. Based on the dynamic indication, the UE may skip the reception or transmission of the one or more channels during the inactive time 615. For example, the BS may refrain from transmitting, and the UE may refrain from monitoring for or receiving, the SPS PDSCH/PDCCH transmissions during one or more inactive times 615 that occur after the dynamic indication is received by the UE. For example, one or more SPS transmissions may be restricted. As shown, the UE may refrain from monitoring for or receiving, and the BS may refrain from transmitting, the SPS PDSCH/PDCCH during restriction windows 620(1)-620(3), which may occur during the inactive time 615 (e.g., the dynamic indication may be applied during restriction windows 620(1)-620(3)). As a result, the BS and the UE may remain in sleep states, and consume minimal power, during the inactive time 615.

As indicated above, FIG. 6 is provided as an example. Other examples may differ from what is described with respect to FIG. 6.

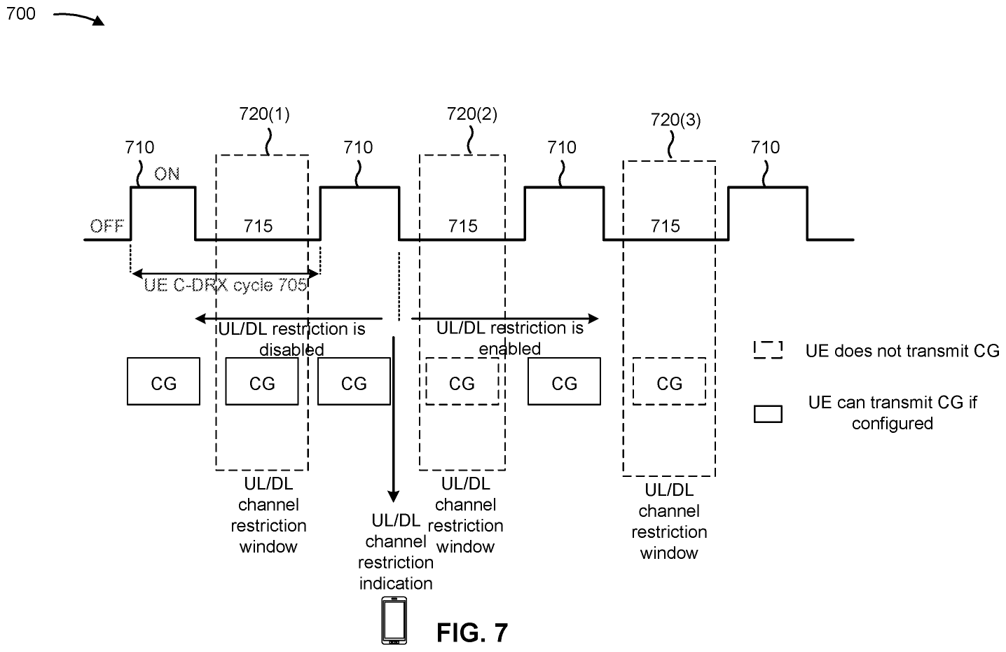

FIG. 7 is a diagram illustrating an example 700 in which a dynamic indication is configured to skip the transmission of configured grants (CGs) by a UE during the inactive times of a DRX configuration, in accordance with the present disclosure.

Example 700 depicts a DRX cycle 705 that is implemented on a UE. The DRX cycle 705 may include alternating active times 710 (e.g., on durations) and inactive times 715 (e.g., off durations). In some examples, the DRX cycle 705 may include one on duration and one off duration and may repeat. The UE may be configured to monitor a PDCCH during the active time 710, and to refrain from monitoring the PDCCH during the inactive time 715. In some examples, the UE may be further configured to send transmissions during the active times 710, and to refrain from sending transmissions during the inactive times 715. In some examples, a BS may be configured to enter a sleep state during the inactive times 715. For example, the BS may be configured to refrain from monitoring for transmissions during the inactive times 715.

In example 700, the UE may be configured to transmit, and the BS may be configured to receive, a CG. For example, one CG may be scheduled during each active time 710 and one CG may be scheduled during each inactive time 715. As shown, before the UE receives the dynamic indication from the BS, the UE transmits at least one CG during an inactive time 715. The UE may wake up (or remain awake) during the inactive time 715, which may enable the UE to transmit the CG during the inactive time 715. The BS may wake up (or remain awake) during the inactive time 715, which may enable the BS to monitor for and receive the CG during the inactive time 715 (e.g., the dynamic indication may be applied during restriction windows 720(1)-720(3)). As a result, before the UE receives the dynamic indication, the BS and the UE may consume more power during the inactive time 715 than the BS and the UE would consume without the CG.

As shown, the BS may output, and the UE may receive, a dynamic indication (“UL/DL channel restriction indication”) to skip reception or transmission of one or more channels during an inactive time 715. Based on the dynamic indication, the UE may skip the reception or transmission of the one or more channels during the inactive time 715. For example, the UE may refrain from transmitting, and the BS may refrain from monitoring for or receiving, the CGs during one or more inactive times 715 that occur after the dynamic indication is received by the UE. For example, one or more CG resources may be restricted. As shown, the UE may refrain from transmitting, and the BS may refrain from monitoring for or receiving, the CGs during restriction windows 720(1)-720(3), which may occur during the inactive time 715. As a result, the BS and the UE may remain in sleep states, and consume minimal power, during the inactive time 715.

As indicated above, FIG. 7 is provided as an example. Other examples may differ from what is described with respect to FIG. 7.

In some cases, the UE may not receive the dynamic indication. For example, the UE may not receive the dynamic indication from the BS when the UE is at an edge of a cell associated with the BS and/or when the UE is under high interference (e.g., when the UE is experiencing interference above a threshold). If the UE does not receive the dynamic indication and the BS enters a sleep state during the inactive time, then the UE may remain awake during the inactive time. For example, during the inactive time, the UE may expend resources to monitor for transmissions that the BS will not send (e.g., because the BS is in a sleep state).

FIG. 8 is a diagram illustrating an example 800 associated with a dynamic indication to skip channel reception or transmission, in accordance with the present disclosure. As shown in FIG. 8, example 800 includes communication between a network node 110 and a UE 120. In some aspects, network node 110 and UE 120 may be included in a wireless network, such as wireless network 100. Network node 110 and UE 120 may communicate via a wireless access link, which may include an uplink and a downlink.

As shown by reference number 810, the network node 110 may output, and the UE 120 may receive, a configuration of cell DTX and cell DRX. For example, the configuration may include an indication of a pattern of active times and non-active times of the cell DTX and/or the cell DRX.

As shown by reference number 820, the network node 110 may output, and the UE 120 may receive, a dynamic indication (e.g., transmitted via Layer 1, Layer 2, or Layer 3) to skip reception or transmission of one or more channels during a time interval. In some examples, the time interval corresponds to a non-active time of the cell DTX or a non-active time of the cell DRX.

By notifying the UE 120 when the skipping is to be enabled, the dynamic indication may prevent one or more transmissions from occurring during the inactive time. As a result, the network node 110 and/or the UE 120 may remain in or enter a sleep state during the inactive time. For example, the network node 110 may enable a cell DTX/DRX mechanism, which may reduce power consumption at the network node 110. If the time interval corresponds to an inactive time of a C-DRX cycle, the UE 120 may apply the dynamic indication during a UE C-DRX cycle. For example, the dynamic indication may enable the restriction windows 510(1)-510(3) shown in FIG. 5A. If the time interval corresponds to a non-active time of a cell DTX/DRX cycle that is configured during a time when the UE 120 is not configured with a C-DRX cycle (e.g., if the UE 120 is not configured with a C-DRX cycle), the UE 120 may apply the dynamic indication independent from a UE C-DRX cycle. For example, the dynamic indication may enable the restriction windows 530(1)-530(3) shown in FIG. 5B.

In some aspects, the UE 120 may transmit, and the network node 110 may obtain, a confirmation that the dynamic indication was received. The confirmation may enable the UE 120 to indicate, to the network node 110, that the dynamic indication was received. For example, upon receiving a confirmation, the network node 110 and UE 120 may enter respective sleep states in a coordinated fashion (e.g., during the time interval). If the network node 110 does not receive the confirmation (e.g., within a threshold amount of time), then the network node 110 may refrain from entering a sleep state and/or the network node 110 may output a subsequent dynamic indication to skip reception or transmission of one or more channels during a time interval. Thus, the confirmation may help ensure that the UE 120 has been notified to skip the reception and/or transmission of the channel(s) and, therefore, that the UE 120 does not expend resources monitoring for transmissions that the network node 110 will not send.

At least four examples are provided of the operation shown at reference number 820 (e.g., where the network node 110 may output, and the UE 120 may receive, the dynamic indication). In a first example, the dynamic indication is included in a DCI (e.g., a DCI that may not include an uplink grant or a downlink grant). In a second example, the dynamic indication is included in a DCI that includes a downlink grant for a broadcast PDSCH. In a third example, the dynamic indication is included in a DCI that includes a downlink grant for a unicast PDSCH. In a fourth example, the dynamic indication is included in a DCI that includes an uplink grant for a unicast PUSCH. Each example is discussed in turn below.

In the first example, the dynamic indication may be included in a DCI (e.g., a DCI that may not include an uplink grant or a downlink grant and, thus, may have no associated PUSCH or PDSCH). For example, the DCI may be configured to carry information regarding the dynamic indication and/or other information, such as information relating to gNB antenna port adaptation or transmit power adaptation. The network node 110 may output the DCI flexibly (e.g., at any suitable time) without waiting for an occurrence that would enable the transmission of the DCI.

The confirmation that the dynamic indication was received may be HARQ-ACK information (e.g., HARQ-ACK feedback). The HARQ-ACK information may be carried in a PUCCH or a PUSCH. In some examples, the DCI may include an uplink grant for the confirmation. The uplink grant may enable the UE to transmit the HARQ-ACK information in a PUCCH or a PUSCH.

The UE 120 may transmit the confirmation a quantity of symbols (e.g., a configured quantity of symbols) after a symbol associated with the DCI. For instance, in response to successfully detecting the PDCCH carrying the DCI, the UE 120 may transmit the confirmation after N symbols from the control resource set (CORESET) symbol where the PDCCH is received by the UE 120 or the PDCCH symbol where the PDCCH is received by the UE 120. In some examples, the UE 120 may transmit the confirmation the quantity of symbols after a symbol of the CORESET (e.g., the last symbol of the CORESET) in which the DCI is received. In some examples, the UE 120 may transmit the confirmation the quantity of symbols after a symbol that includes the DCI (e.g., a last symbol of the DCI in the CORESET). When transmitted a quantity of symbols after a symbol associated with the DCI, the confirmation may have low latency (e.g., the UE 120 may transmit the confirmation at any suitable time, such as within a threshold time of receiving the DCI).

The UE 120 may apply the dynamic indication a quantity of symbols (e.g., a configured quantity of symbols) after a symbol associated with the confirmation. For example, in response to successfully receiving the PDCCH carrying the dynamic indication, the UE 120 may apply the dynamic indication X symbols after the last symbol of the PUCCH or PUSCH transmitting the HARQ-ACK information. Based on the timing of the application of the dynamic indication, the network node 110 and the UE 120 may align the timing of respective sleep states.

The symbol duration(s) used to determine the quantity of symbols after which the confirmation may be transmitted or the quantity of symbols after which the dynamic indication may be applied may be based on a subcarrier spacing (SCS). The SCS used to determine the symbol duration(s) may be a first SCS of the active downlink bandwidth part (BWP) over which the PDCCH that includes the dynamic indication is received (e.g., the SCS of the PDCCH containing the DCI that includes the dynamic indication) and/or a second SCS of the active uplink BWP over which the confirmation (e.g., PUCCH/PUSCH) is transmitted (e.g., the SCS of the channel carrying the HARQ-ACK information). For example, the SCS may be a minimum of the first SCS and the second SCS. In some examples, the SCS may be fixed in a standard.

The DCI that includes the dynamic indication may be signaled in a UE-specific manner or multicast to a UE group (e.g., a UE group that includes the UE 120). When the DCI is signaled in a UE-specific manner, the DCI may carry an uplink grant for the UE 120 to send the HARQ-ACK information in a PUCCH or PUSCH. For example, the UE 120 may transmit the confirmation a quantity of symbols (e.g., a configured quantity of symbols) after a symbol associated with the DCI. When the DCI is multicast to the UE group, the network node 110 may output (e.g., transmit) the DCI to a plurality of UEs (e.g., including the UE 120) belonging to the UE group, and the UE group (e.g., including the UE 120) may receive the DCI. In some examples, the DCI may carry a plurality of uplink grants for a plurality of confirmations for the plurality of respective UEs belonging to the UE group. Multicasting the DCI to a UE group may enable the network node 110 to transmit the DCI to multiple UEs simultaneously, which may reduce overhead involved in transmitting the DCI (e.g., the overhead may be below a threshold). For example, the DCI and/or the broadcast PDSCH may enable the network node 110 to align the timing of respective sleep states across multiple UEs of the UE group.

In some examples, the network node 110 may output, and the UE 120 may receive, a configuration of a resource for transmitting the confirmation that the UE 120 successfully received the PDCCH carrying the dynamic indication. The resource May be configured separately from the PDCCH (e.g., in a separate transmission, via a separate process, or the like). For instance, the resource may be configured via RRC.

In some examples, the network node 110 may output, and the UE 120 may receive, an RRC configuration of a common resource configured for the UE group. For instance, the network node 110 may configure the common resource, via RRC, for the UEs (including UE 120) in the UE group. In some examples, the network node 110 may output, and the UE 120 may receive, an RRC configuration of a resource configured for the UE 120. The resource may be one of a plurality of resources configured for respective UEs of the UE group. For instance, the network node 110 may configure separate (e.g., individual) resources, via RRC, for the different (e.g., respective) UEs in the UE group.

In case the DCI is multicast to the UE group, the network node 110 may output the DCI to a plurality of UEs (e.g., including the UE 120) belonging to the UE group. In some examples, when the network node 110 transmits the DCI in a UE-group manner, the network node 110 may refrain from configuring a resource for transmitting the confirmation, and the UE 120 may refrain from transmitting a confirmation. The plurality of UEs (e.g., including the UE 120) may receive the DCI and refrain from transmitting a confirmation that the dynamic indication was received. Refraining from transmitting the confirmation may reduce overhead compared to a case where, for example, each UE in the UE group that receives the DCI transmits a confirmation that the DCI was received.

In the second example, the dynamic indication may be included in DCI that also includes a downlink grant for a broadcast PDSCH. For example, the DCI may be a DCI for paging (e.g., DCI format 1_0 with cyclic redundancy check (CRC) scrambled by paging radio network temporary identifier (P-RNTI)), a DCI for SI, or the like. In some examples, the network node 110 may transmit the DCI and/or the broadcast PDSCH to multiple UEs simultaneously (e.g., in a cell-specific or UE-group manner), which may help reduce resources involved in transmitting the DCI and/or the broadcast PDSCH compared to providing respective transmissions to each UE associated with the cell.

The confirmation that the dynamic indication was received may be HARQ-ACK information (e.g., HARQ-ACK feedback). The HARQ-ACK information may be carried in a PUCCH or a PUSCH. In some examples, the DCI may include an uplink grant for the confirmation. The uplink grant may enable the UE to transmit the HARQ-ACK information in a PUCCH or a PUSCH.

In some examples, the UE 120 may transmit the confirmation a quantity of symbols (e.g., a configured quantity of symbols) after a symbol associated with the DCI. For instance, in response to successfully detecting the PDCCH carrying the DCI, the UE 120 may transmit the confirmation after N symbols from the CORESET symbol where the PDCCH is received by the UE 120 or the PDCCH symbol where the PDCCH is received by the UE 120. In some examples, the UE 120 may transmit the confirmation the quantity of symbols after a symbol of the CORESET (e.g., the last symbol of the CORESET) in which the DCI is received. In some examples, the UE 120 may transmit the confirmation the quantity of symbols after a symbol that includes the DCI (e.g., a last symbol of the DCI in the CORESET). When transmitted a quantity of symbols after a symbol associated with the DCI, the confirmation may have low latency because the UE 120 may transmit the confirmation at any suitable time (e.g., within a threshold time of receiving the DCI).

In some examples, the UE 120 may receive the broadcast PDSCH and, in response to receiving the broadcast PDSCH, transmit the confirmation a quantity of symbols (e.g., a configured quantity of symbols) after a symbol associated with the broadcast PDSCH. For instance, in response to successfully detecting the dynamic indication, the UE 120 may transmit the confirmation after N symbols from a symbol (e.g., the last symbol) where the UE 120 receives the broadcast PDSCH. Because a UE would not typically provide HARQ-ACK feedback in response to a broadcast PDSCH, transmitting the confirmation a quantity of symbols after a symbol associated with the broadcast PDSCH may enable the UE 120 to signal to the network node 110 that the UE 120 successfully received the dynamic indication.

The UE 120 may apply the dynamic indication a quantity of symbols (e.g., a configured quantity of symbols) after a symbol associated with the confirmation. For example, in response to successfully receiving the PDCCH carrying the dynamic indication, the UE 120 may apply the dynamic indication X symbols after the last symbol of the PUCCH or PUSCH transmitting the HARQ-ACK information. Based on the timing of the application of the dynamic indication, the network node 110 and the UE 120 may align the timing of respective sleep states.

The symbol duration(s) for the quantity of symbols after which the confirmation may be transmitted or the quantity of symbols after which the dynamic indication may be applied may be based on an SCS. The SCS used to determine the symbol duration may be a first SCS of the active downlink BWP over which the PDCCH that includes the dynamic indication is received (e.g., the SCS of the PDCCH containing the DCI that includes the dynamic indication), a second SCS of the active downlink BWP over which the broadcast PDSCH is received (e.g., the SCS of the broadcast PDSCH), and/or a third SCS of the active uplink BWP over which the confirmation (e.g., PUCCH/PUSCH) is transmitted (e.g., the SCS of the channel carrying the HARQ-ACK information). For example, the SCS may be a minimum of the first SCS, the second SCS, and the third SCS. In some examples, the SCS may be fixed in a standard.

In the third or fourth examples, the dynamic indication may be included in DCI that also includes a downlink grant for a unicast PDSCH or an uplink grant for a unicast PUSCH. The DCI may be transmitted in a UE-specific manner. In some examples, the DCI (e.g., the downlink grant), and the unicast PDSCH or the unicast PUSCH, may be transmitted regardless of whether the dynamic indication is present in the DCI. Thus, the UE 120 may transmit the confirmation as a transmission that would be transmitted regardless of whether the dynamic indication is present in the DCI, which may result in lower overhead involved in transmitting the confirmation (e.g., the overhead may be below a threshold) than if the UE 120 were to transmit a separate, dedicated confirmation (for instance). For example, the network node 110 may treat, as the confirmation, a HARQ-ACK information transmitted in response to the unicast PDSCH or the unicast PUSCH transmitted in response to the DCI.

With reference to the third example, the network node 110 may output, and the UE 120 may receive, DCI that includes the dynamic indication and a downlink grant for a unicast PDSCH. The UE 120 may receive the unicast PDSCH (e.g., after receiving the DCI). In some examples, the UE 120 may transmit, and the network node 110 may obtain, HARQ-ACK information based at least in part on (e.g., in response to) the unicast PDSCH. The HARQ-ACK information may serve as the confirmation that the UE 120 received the dynamic indication.

The UE 120 may apply the dynamic indication a quantity of symbols (e.g., a configured quantity of symbols) after a symbol associated with the unicast PDSCH. For example, in response to successfully receiving the unicast PDSCH, the UE 120 may apply the dynamic indication X symbols after the last symbol of a PUCCH or a PUSCH transmitting the HARQ-ACK information. Based on the timing of the application of the dynamic indication, the network node 110 and the UE 120 may align the timing of respective sleep states.

The symbol duration for the quantity of symbols after which the dynamic indication may be applied may be based on an SCS. The SCS used to determine the symbol duration may be a first SCS of the active downlink BWP over which the PDCCH that includes the dynamic indication is received or a second SCS of the active uplink BWP over which the confirmation (e.g., PUCCH/PUSCH carrying the HARQ-ACK information) is transmitted. In some examples, the SCS may be fixed in a standard.

With reference to the fourth example, the network node 110 may output, and the UE 120 may receive, DCI that includes the dynamic indication and an uplink grant for a unicast PUSCH. The UE 120 may transmit, and the network node 110 may obtain, the unicast PUSCH, which may serve as the confirmation that the UE 120 received the dynamic indication.

The UE 120 may apply the dynamic indication a quantity of symbols after a symbol associated with the unicast PUSCH (e.g., a configured quantity of symbols after a last symbol of the unicast PUSCH). For example, in response to successfully receiving the unicast PDSCH, the UE 120 may apply the dynamic indication X symbols after the last symbol of the unicast PUSCH. Based on the timing of the application of the dynamic indication, the network node 110 and the UE 120 may align the timing of respective sleep states.

The symbol duration for the quantity of symbols after which the dynamic indication may be applied may be based on an SCS. The SCS used to determine the symbol duration may be a first SCS of the active downlink BWP over which the PDCCH that includes the dynamic indication is received or a second SCS of the active uplink BWP over which the confirmation (e.g., the unicast PUSCH) is transmitted. In some examples, the SCS may be fixed in a standard.

In some aspects, the first example, the second example, the third example, or the fourth example may be implemented alone (e.g., a system may implement only the first example, only the second example, only the third example, or only the fourth example). In some aspects, two or more of the first example, the second example, the third example, or the fourth example may be implemented in combination with each other. For example, different examples may be implemented based on a time at which the UE 120 receives the dynamic indication. For example, if the UE 120 receives the DCI outside the active time, then the dynamic indication may not include a downlink grant or an uplink grant for downlink or uplink scheduling and, as a result, the first example may apply. Or, if UE receives a dynamic indication within an active time, then the dynamic indication may include a downlink grant or an uplink grant for downlink or uplink scheduling and, as a result, the third example or the fourth example may apply.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with a dynamic indication to skip channel reception or transmission.

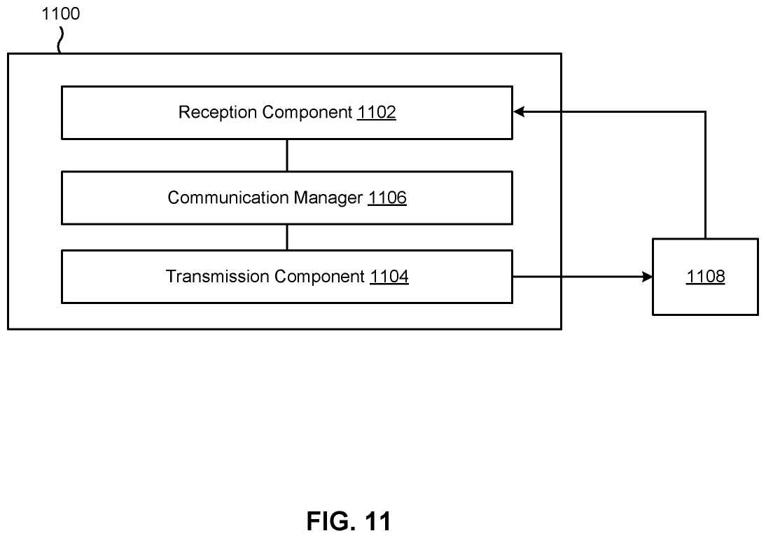

As shown in FIG. 9, in some aspects, process 900 may include receiving a configuration of cell DTX and cell DRX (block 910). For example, the UE (e.g., using reception component 1102 and/or communication manager 1106, depicted in FIG. 11) may receive a configuration of cell DTX and cell DRX, as described above.

As further shown in FIG. 9, in some aspects, process 900 may include receiving a dynamic indication to skip reception or transmission of one or more channels during a time interval (block 920). For example, the UE (e.g., using reception component 1102 and/or communication manager 1106, depicted in FIG. 11) may receive a dynamic indication to skip reception or transmission of one or more channels during a time interval, as described above.

Process 900 may include additional aspects, such as any single aspect or any combination of aspects described below and/or in connection with one or more other processes described elsewhere herein.

In a second aspect, alone or in combination with the first aspect, the time interval corresponds to a non-active time of the cell DTX or a non-active time of the cell DRX.

In a third aspect, alone or in combination with one or more of the first and second aspects, process 900 includes applying the dynamic indication a quantity of symbols after a symbol associated with a confirmation that the dynamic indication was received.

In a fourth aspect, alone or in combination with one or more of the first through third aspects, receiving the dynamic indication includes receiving downlink control information that includes the dynamic indication, wherein the downlink control information is multicast to a UE group that includes the UE.

In a fifth aspect, alone or in combination with one or more of the first through fourth aspects, process 900 includes transmitting hybrid automatic repeat request acknowledgment information.

In a sixth aspect, alone or in combination with one or more of the first through fifth aspects, process 900 includes transmitting a confirmation that the dynamic indication was received a quantity of symbols after a symbol associated with the downlink control information.

In a seventh aspect, alone or in combination with one or more of the first through sixth aspects, process 900 includes receiving a configuration of a resource for transmitting a confirmation that the dynamic indication was received.

In an eighth aspect, alone or in combination with one or more of the first through seventh aspects, receiving the configuration of the resource for transmitting the confirmation includes receiving a radio resource control configuration of a common resource configured for the UE group.

In a ninth aspect, alone or in combination with one or more of the first through seventh aspects, receiving the configuration of the resource for transmitting the confirmation includes receiving a radio resource control configuration of a resource configured for the UE, wherein the resource is one of a plurality of resources configured for respective UEs of the UE group.

In a tenth aspect, alone or in combination with one or more of the first through ninth aspects, the dynamic indication is a first dynamic indication, the one or more channels are one or more first channels, and the time interval is a first time interval, and process 900 includes receiving downlink control information that includes a second dynamic indication to skip reception or transmission of one or more second channels during a second time interval, wherein the downlink control information is multicast to a UE group that includes the UE.

In an eleventh aspect, alone or in combination with one or more of the first through tenth aspects, receiving the dynamic indication includes receiving downlink control information that includes the dynamic indication and a downlink grant for a broadcast PDSCH.

In a twelfth aspect, alone or in combination with one or more of the first through eleventh aspects, process 900 includes transmitting hybrid automatic repeat request acknowledgment information.

In a thirteenth aspect, alone or in combination with one or more of the first through twelfth aspects, process 900 includes transmitting a confirmation that the dynamic indication was received a quantity of symbols after a symbol associated with the downlink control information.

In a fourteenth aspect, alone or in combination with one or more of the first through thirteenth aspects, process 900 includes receiving the PDSCH; and transmitting a confirmation that the dynamic indication was received a quantity of symbols after a symbol associated with the broadcast PDSCH.

In a fifteenth aspect, alone or in combination with one or more of the first through fourteenth aspects, receiving the dynamic indication includes receiving downlink control information that includes the dynamic indication and a downlink grant for a unicast PDSCH.

In a sixteenth aspect, alone or in combination with one or more of the first through fifteenth aspects, process 900 includes receiving the unicast PDSCH; and transmitting hybrid automatic repeat request acknowledgment information based at least in part on the unicast PDSCH.

In a seventeenth aspect, alone or in combination with one or more of the first through sixteenth aspects, receiving the dynamic indication includes receiving downlink control information that includes the dynamic indication and an uplink grant for a unicast PUSCH.

In an eighteenth aspect, alone or in combination with one or more of the first through seventeenth aspects, transmitting the confirmation includes transmitting the unicast PUSCH.

In a nineteenth aspect, alone or in combination with one or more of the first through eighteenth aspects, applying the dynamic indication includes applying the dynamic indication a quantity of symbols after a last symbol of the unicast PUSCH.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with confirmation of dynamic indication to skip reception or transmission during the time interval.

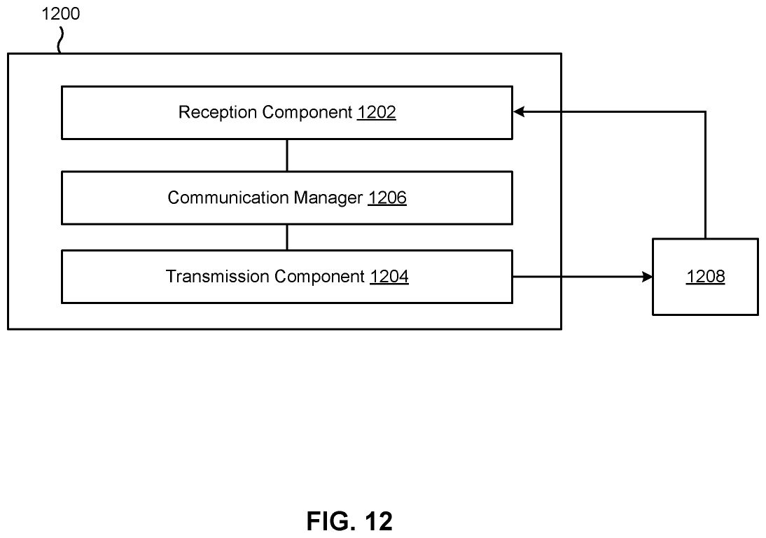

As shown in FIG. 10, in some aspects, process 1000 may include transmitting a configuration of cell DTX and cell DRX (block 1010). For example, the network node (e.g., using transmission component 1204 and/or communication manager 1206, depicted in FIG. 12) may transmit a configuration of cell DTX and cell DRX, as described above.

As shown in FIG. 10, in some aspects, process 1000 may include transmitting a dynamic indication to skip reception or transmission of one or more channels during a time interval (block 1020). For example, the network node (e.g., using transmission component 1204 and/or communication manager 1206, depicted in FIG. 12) may transmit a dynamic indication to skip reception or transmission of one or more channels during a time interval, as described above.

Process 1000 may include additional aspects, such as any single aspect or any combination of aspects described below and/or in connection with one or more other processes described elsewhere herein.

In a first aspect, the time interval corresponds to a non-active time of the cell DTX or a non-active time of the cell DRX.

In a second aspect, alone or in combination with the first aspect, transmitting the dynamic indication includes transmitting downlink control information that includes the dynamic indication, wherein the downlink control information is multicast to a UE group.

In a third aspect, alone or in combination with one or more of the first and second aspects, transmitting the dynamic indication includes transmitting downlink control information that includes the dynamic indication and a downlink grant for a broadcast PDSCH.

In a fourth aspect, alone or in combination with one or more of the first through third aspects, transmitting the dynamic indication includes transmitting downlink control information that includes the dynamic indication and a downlink grant for a unicast PDSCH.

In a fifth aspect, alone or in combination with one or more of the first through fourth aspects, transmitting the dynamic indication includes transmitting downlink control information that includes the dynamic indication and an uplink grant for a unicast PUSCH.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a configuration of cell DTX and cell DRX. The reception component 1102 may receive a dynamic indication to skip reception or transmission of one or more channels during a time interval.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIG. 8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit a configuration of cell DTX and cell DRX. The transmission component 1204 may transmit a dynamic indication to skip reception or transmission of one or more channels during a time interval.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving a configuration of cell DTX and cell DRX; and receiving a dynamic indication to skip reception or transmission of one or more channels during a time interval.

Aspect 2: The method of any of Aspect 1, wherein the time interval corresponds to a non-active time of the cell DTX or a non-active time of the cell DRX.

Aspect 3: The method of any of Aspects 1-2, further comprising: applying the dynamic indication a quantity of symbols after a symbol associated with a confirmation that the dynamic indication was received.

Aspect 4: The method of any of Aspects 1-3, wherein receiving the dynamic indication includes: receiving downlink control information that includes the dynamic indication, wherein the downlink control information is multicast to a UE group that includes the UE.

Aspect 5: The method of Aspect 4, further comprising: transmitting hybrid automatic repeat request acknowledgment information.

Aspect 6: The method of Aspect 4, further comprising: transmitting a confirmation that the dynamic indication was received a quantity of symbols after a symbol associated with the downlink control information.

Aspect 7: The method of Aspect 4, further comprising: receiving a configuration of a resource for transmitting a confirmation that the dynamic indication was received.

Aspect 8: The method of Aspect 7, wherein receiving the configuration of the resource for transmitting the confirmation includes: receiving a radio resource control configuration of a common resource configured for the UE group.

Aspect 9: The method of Aspect 7, wherein receiving the configuration of the resource for transmitting the confirmation includes: receiving a radio resource control configuration of a resource configured for the UE, wherein the resource is one of a plurality of resources configured for respective UEs of the UE group.

Aspect 10: The method of any of Aspects 1-9, wherein the dynamic indication is a first dynamic indication, the one or more channels are one or more first channels, and the time interval is a first time interval, the method further comprising: receiving downlink control information that includes a second dynamic indication to skip reception or transmission of one or more second channels during a second time interval, wherein the downlink control information is multicast to a UE group that includes the UE.

Aspect 11: The method of any of Aspects 1-10, wherein receiving the dynamic indication includes: receiving downlink control information that includes the dynamic indication and a downlink grant for a broadcast PDSCH.

Aspect 12: The method of Aspect 11, further comprising: transmitting hybrid automatic repeat request acknowledgment information.

Aspect 13: The method of Aspect 11, further comprising: transmitting a confirmation that the dynamic indication was received a quantity of symbols after a symbol associated with the downlink control information.

Aspect 14: The method of Aspect 11, further comprising: receiving the broadcast PDSCH; and transmitting a confirmation that the dynamic indication was received a quantity of symbols after a symbol associated with the broadcast PDSCH.

Aspect 15: The method of any of Aspects 1-14, wherein receiving the dynamic indication includes: receiving downlink control information that includes the dynamic indication and a downlink grant for a unicast PDSCH.

Aspect 16: The method of Aspect 15, further comprising: receiving the unicast PDSCH; and transmitting hybrid automatic repeat request acknowledgment information based at least in part on the unicast PDSCH.

Aspect 17: The method of any of Aspects 1-16, wherein receiving the dynamic indication includes: receiving downlink control information that includes the dynamic indication and an uplink grant for a unicast PUSCH.

Aspect 18: The method of Aspect 17, further comprising: transmitting the unicast PUSCH.

Aspect 19: The method of Aspect 18, wherein applying the dynamic indication includes: applying the dynamic indication a quantity of symbols after a last symbol of the unicast PUSCH.

Aspect 20: A method of wireless communication performed by a network node, comprising: transmitting a configuration of cell discontinuous transmission and cell discontinuous reception; and transmitting a dynamic indication to skip reception or transmission of one or more channels during a time interval.

Aspect 21: A method of Aspect 20, wherein the time interval corresponds to a non-active time of the cell DTX or a non-active time of the cell DRX.

Aspect 22: The method of Aspect 20, wherein transmitting the dynamic indication includes: transmitting downlink control information that includes the dynamic indication, wherein the downlink control information is multicast to a UE group.

Aspect 23: The method of any of Aspects 20-22, wherein transmitting the dynamic indication includes: transmitting downlink control information that includes the dynamic indication and a downlink grant for a broadcast PDSCH.

Aspect 24: The method of any of Aspects 20-23, wherein transmitting the dynamic indication includes: transmitting downlink control information that includes the dynamic indication and a downlink grant for a unicast PDSCH.

Aspect 25: The method of any of Aspects 20-24, wherein transmitting the dynamic indication includes: transmitting downlink control information that includes the dynamic indication and an uplink grant for a unicast PUSCH.

Aspect 26: An apparatus for wireless communication at a device, comprising a processor; memory coupled with the processor; and instructions stored in the memory and executable by the processor to cause the apparatus to perform the method of one or more of Aspects 1-25.

Aspect 27: A device for wireless communication, comprising a memory and one or more processors coupled to the memory, the one or more processors configured to perform the method of one or more of Aspects 1-25.

Aspect 28: An apparatus for wireless communication, comprising at least one means for performing the method of one or more of Aspects 1-25.

Aspect 29: A non-transitory computer-readable medium storing code for wireless communication, the code comprising instructions executable by a processor to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a configuration of cell discontinuous transmission and cell discontinuous reception; and
receive a dynamic indication to skip reception or transmission of one or more channels during a time interval.

2. The UE of claim 1, wherein the time interval corresponds to a non-active time of the cell discontinuous transmission or a non-active time of the cell discontinuous reception.

3. The UE of claim 1, wherein the one or more processors are further configured to:
apply the dynamic indication a quantity of symbols after a symbol associated with a confirmation that the dynamic indication was received.

4. The UE of claim 1, wherein the one or more processors, to receive the dynamic indication, are configured to:
receive downlink control information that includes the dynamic indication, wherein the downlink control information is multicast to a UE group that includes the UE.

5. The UE of claim 4, wherein the one or more processors are configured to:
transmit hybrid automatic repeat request acknowledgment information.

6. The UE of claim 4, wherein the one or more processors are configured to:
transmit a confirmation that the dynamic indication was received a quantity of symbols after a symbol associated with the downlink control information.

7. The UE of claim 4, wherein the one or more processors are further configured to:
receive a configuration of a resource for transmitting a confirmation that the dynamic indication was received.

8. The UE of claim 7, wherein the one or more processors, to receive the configuration of the resource for transmitting the confirmation, are configured to:
receive a radio resource control configuration of a common resource configured for the UE group.

9. The UE of claim 7, wherein the one or more processors, to receive the configuration of the resource for transmitting the confirmation, are configured to:
receive a radio resource control configuration of a resource configured for the UE, wherein the resource is one of a plurality of resources configured for respective UEs of the UE group.

10. The UE of claim 1, wherein the dynamic indication is a first dynamic indication, the one or more channels are one or more first channels, and the time interval is a first time interval, and wherein the one or more processors are further configured to:
receive downlink control information that includes a second dynamic indication to skip reception or transmission of one or more second channels during a second time interval, wherein the downlink control information is multicast to a UE group that includes the UE.

11. The UE of claim 1, wherein the one or more processors, to receive the dynamic indication, are configured to:
receive downlink control information that includes the dynamic indication and a downlink grant for a broadcast physical downlink shared channel.

12. The UE of claim 11, wherein the one or more processors are configured to:
transmit hybrid automatic repeat request acknowledgment information.

13. The UE of claim 11, wherein the one or more processors are configured to:
transmit a confirmation that the dynamic indication was received a quantity of symbols after a symbol associated with the downlink control information.

14. The UE of claim 11, wherein the one or more processors are further configured to:
receive the broadcast physical downlink shared channel; and
transmit a confirmation that the dynamic indication was received a quantity of symbols after a symbol associated with the broadcast physical downlink shared channel.

15. The UE of claim 1, wherein the one or more processors, to receive the dynamic indication, are configured to:
receive downlink control information that includes the dynamic indication and a downlink grant for a unicast physical downlink shared channel (PDSCH).

16. The UE of claim 15, wherein the one or more processors are further configured to:
receive the unicast physical downlink shared channel; and
transmit hybrid automatic repeat request acknowledgment information based at least in part on the unicast PDSCH.

17. The UE of claim 1, wherein the one or more processors, to receive the dynamic indication, are configured to:
receive downlink control information that includes the dynamic indication and an uplink grant for a unicast physical uplink shared channel (PUSCH).

18. The UE of claim 17, wherein the one or more processors are configured to:
transmit the unicast PUSCH.

19. The UE of claim 18, wherein the one or more processors, to apply the dynamic indication, are configured to:
apply the dynamic indication a quantity of symbols after a last symbol of the unicast PUSCH.

20. A network node for wireless communication, comprising:
a memory; and
one or more processors, coupled to the memory, configured to:
transmit a configuration of cell discontinuous transmission and cell discontinuous reception; and
transmit a dynamic indication to skip reception or transmission of one or more channels during a time interval.

21. The network node of claim 20, wherein the time interval corresponds to a non-active time of the cell discontinuous transmission or a non-active time of the cell discontinuous reception.

22. The network node of claim 20, wherein the one or more processors, to transmit the dynamic indication, are configured to:
transmit downlink control information that includes the dynamic indication, wherein the downlink control information is multicast to a user equipment (UE) group.

23. The network node of claim 20, wherein the one or more processors, to transmit the dynamic indication, are configured to:
transmit downlink control information that includes the dynamic indication and a downlink grant for a broadcast physical downlink shared channel.

24. The network node of claim 20, wherein the one or more processors, to transmit the dynamic indication, are configured to:
transmit downlink control information that includes the dynamic indication and a downlink grant for a unicast physical downlink shared channel.

25. The network node of claim 20, wherein the one or more processors, to transmit the dynamic indication, are configured to:
transmit downlink control information that includes the dynamic indication and an uplink grant for a unicast physical uplink shared channel.

26. A method of wireless communication performed by a user equipment (UE), comprising:
receiving a configuration of cell discontinuous transmission and cell discontinuous reception; and
receiving a dynamic indication to skip reception or transmission of one or more channels during a time interval.

27. The method of claim 26, wherein the time interval corresponds to a non-active time of the cell discontinuous transmission or a non-active time of the cell discontinuous reception.

28. The method of claim 26, wherein receiving the dynamic indication includes:
receiving downlink control information that includes the dynamic indication, wherein the downlink control information is multicast to a UE group that includes the UE.

29. A method of wireless communication performed by a network node, comprising:
transmitting a configuration of cell discontinuous transmission and cell discontinuous reception; and
transmitting a dynamic indication to skip reception or transmission of one or more channels during a time interval.

30. The method of claim 29, wherein transmitting the dynamic indication includes:
transmitting downlink control information that includes the dynamic indication, wherein the downlink control information is multicast to a user equipment (UE) group.
